(19) United States
(12) Patent Application Publication
(10) Pub. No.: US 2008/0154713 A1
(43) Pub. Date: Jun. 26, 2008

(54) ON-DEMAND AND POINT-OF-SALE PERSONALIZED PRODUCT-RELATED INFORMATION

(76) Inventors: Robert Roy Buckley, Rochester, NY (US); Dale Ellen Gaucas, Rochester, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/613,316

(22) Filed: Dec. 20, 2006

(51) Int. Cl. G06Q 30/00

(52) U.S. Cl. 705/14; 705/27; 705/16; 705/23; 705/1

(57) ABSTRACT

An information delivery method and system includes a first token receiving device located at the point of display of a product in a store. The first device receives a token and a request for product-related information. A second token receiving device is positioned at or after a point of sale in the store. If the token holder purchased the product, the token holder may use the second token receiving device to receive the requested product-related information.

### BACKGROUND

There are many devices that dispense coupons to customers at retail establishments. Often these coupons are dispensed in kiosks or stationary displays. In one example, U.S. Patent Application Publication Number 2005/0267804, the disclosure of which is incorporated herein by reference, discusses the use of kiosks in retail centers which are used to dispense coupons. The coupons correspond with the particular establishment and the kiosk offers customers a choice as to the types of coupons they can receive. The coupons are categorized in two groups and the customer can choose a coupon from within a group. In another example, U.S. Patent Application Publication Number 2005/0234771, the disclosure of which is incorporated herein by reference, discusses an intelligent in-store coupon system that tracks a customer and offers a coupon to the customer at the point of sale and/or the point of decision. The coupon delivery system could also be connected to a media broadcasting system. Both of these devices are limited to dispensing coupons. Furthermore, a customer can only request a coupon at the location where the coupon is received.

There are also devices that currently assist a customer in shopping. However, these devices do not dispense information to the customer based on customer requests and purchases. Other systems assist customers in generating shopping lists such as described in U.S. Pat. No. 7,107,221, the disclosure of which is incorporated herein by reference, but do not produce product-related information when the product is purchased.

Therefore, the disclosure contained herein describes methods of resolving one or more of the problems discussed above.

### SUMMARY

In an embodiment, an information delivery method includes receiving a first token by a first token receiving device at a point of display of a product. The method may associate the token with product-related information, determine whether the product was purchased; retrieve the product-related information if the product was purchasers, and deliver the product-related information at a point of delivery. The point of delivery is distant from the point of display. Optionally, the point of delivery is a point of sale.

In an embodiment, determining whether the product was purchased includes receiving the token at a point of sale by a second token receiving device. The method also may include receiving, by the first token receiving device, a request for the product-related information. The associating may include associating the token with the requested product-related information, and the associating may also include associating the token with additional product-related information other than the requested information.

In an embodiment, the token-receiving device may include an input interface, such as a touch screen, mouse, keypad, optical receiver, or scanner, to receive requests for the product related information.

The token may be a device such as a storage device, card with a radio frequency identification tag, a card with a magnetic strip, or a card with an optical strip. The product-related information may include information such as a recipe, coupon, newsletter, health benefits description, list of complementary product, or instructions.

Optionally, the point of display may be a product display location in a store, and the point of delivery may be a checkout location in the store. Alternatively, the point of display may be a product display location in a store, and the point of delivery may be positioned after a checkout location and before an exit in the store.

Optionally, the method wherein delivering the product-elated information includes e-mailing the product-related information. Alternatively, delivering the product-related information includes printing the product-related information, such as at a print kiosk. Delivering the product-related information may include placing the product-related information on a website with a personalized uniform resource identifier and providing a holder of the token with the personalized uniform resource identifier. The product-related information accessed via the personalized uniform resource identifier may be downloaded and printed.

In another embodiment, a system includes a token; a first token receiving device located at a point of display of a product in a store; a product-related information server which receives a request for product-related information from the first token receiving device and retrieves the product-related information; a second token receiving device located at a point of sale in the store; and an information delivery device that delivers the product-related information at a point of delivery that is positioned at or after the point of sale.

Optionally, the first token reader also includes a product information input mechanism, such as a bar code scanner. The information delivery device may include a printer. The token may store personal identification information corresponding to the user. The first token reader may be associated with a single product or with multiple products.

### BRIEF DESCRIPTION OF THE DRAWINGS

FIG. 1 depicts one embodiment of a token being used to obtain product-related information.

FIG. 2 depicts a flowchart of one possible embodiment of associating and retrieving product-related information.

FIG. 3 depicts a possible detailed embodiment of associating produce-related information.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

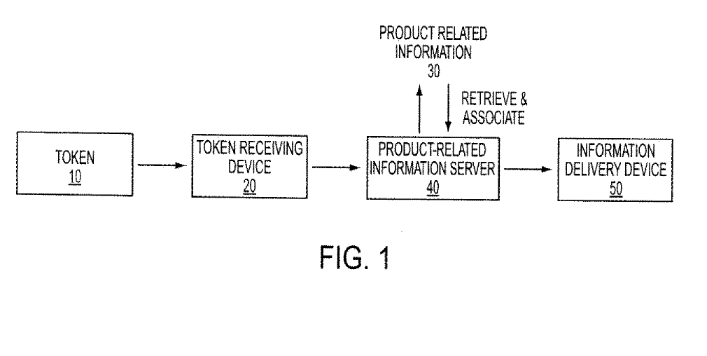

FIG. 1 shows one embodiment of a system in which a token 10 being used to obtain information related to a product. In order to obtain product-related information 30, a request may be made using a token 10. A token 10 is a device which can be used (along with a token receiving device 20) to obtain information related to a product. A token 10 may be, but is not limited to, a cell phone, electronic memory stick, magnetic or smart card, other electronic device or other changeable or fixed machine-readable code. A token may be a storage device, or it may be a card with a radio frequency identification (“RFID”) tag, magnetic strip, or optical strip, or it may be another item that contains and transmits personal identification information. Personal identification information may identify a person or it may identify the token itself. For example, personal identification information may include a person's name, account number, driver's license number, e-mail address, or other unique identifier, or it may include a code that is associated with the particular token. In either event, the token has a unique identifier that allows the system to identify the token, the token holder, or both as the person who uses the token moves around a shopping area to different token receiving devices. The unique identifier may, in some embodiments, point to information contained in a memory such as a database having information obtained during a customer registration process. In one embodiment, a token 10 may be used by customers who are shopping in the store, shopping mall, or other area, all of which are referred to herein collectively as a store.

A token 10 may be associated with a particular customer when it used by that customer. A token may have a unique identification so that the system knows that the token holder is the same throughout the customer's time in the store. In one embodiment, a token 10 may be permanently associated with a customer. For example, a customer may own a store-specific rewards card with a barcode, magnetic strip, or a smart card. In another embodiment, a token 10 may only be associated with the customer for a single or one-time use. For example, a customer may pick up a transmitter and use it as a token when entering the store and drop it off when the customer is finished shopping. Alternatively, a token 10 may have both permanent and single use aspects. For example, a token 10 may be a device that a customer picks up in the store, but that token 10 can be programmed to contain that customer's unique identification. The customer may be using a different token each time, but the identification for that customer may remain the same every time.

A token 10 can be used together with a token receiving device 20 to allow a customer to request product-related information 30. A token receiving device 20 may be a device that can read the information on a token 10. For example, if a token 10 is a card having a magnetic strip, the token receiving device 20 may be a card-reader that reads the data contained on the strip. In one embodiment, the token receiving device 20 may be located at a point of display of a product. As used herein, point of display means a location in a store that is in close proximity to the location at which a particular product is displayed within the store. In one embodiment, a point of display of a product includes a location where a customer can see both a product and a token receiving device. In another embodiment, the point of display includes a location surrounding a product and including, but not limited to, a location where a product and the token receiving device are in arms-length proximity of an ordinary customer. In yet another embodiment, the point of display includes a location of a token receiving device and an associated product on a display case or display shelf, or at the end cap of an aisle or row. For example, a token receiving device 20 may be located next to, or in the vicinity of, a DVD player in an electronic store. If a customer wants to receive product-related information 30 for the DVD player, such as an instruction manual or warranty guide, then the customer may apply the token 10 to the token receiving device 20 at the product's point of display.

When a first token 10 is received by a first token receiving device 20, data obtained from the token 10 may be associated with product-related information 30 through the use of a product-related information server 40. Product-related information 30 may be data about or corresponding to a good for sale. Product-related information 30 obtained may include, but is not limited to coupons, recipes, newsletters, health benefits, accessories, literature, assembly insertions, large print versions of product information, lists or descriptions of related products, or other ancillary information relating to the product at the point of display.

Product-related information 30 may be stored in a product-related information server 40. In one embodiment, the product-related information server 40 may include or contain a database. The product-related information sever 40 may be located at the point of display, at the point of delivery, or another location. In one embodiment, the product-related information sever 40 may be located in a distant location and accessed electronically through a communications network such as the internet by wired and/or wireless communication.

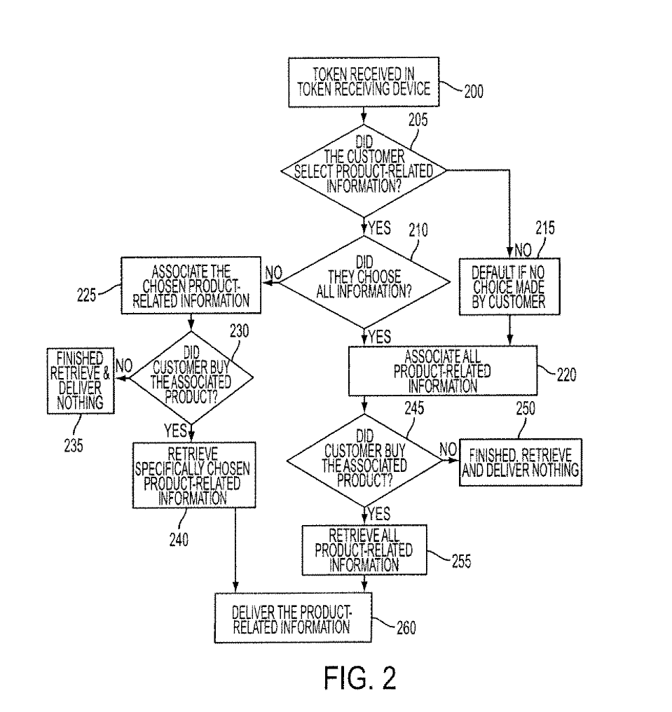

The product-elated information server 40 may be used to obtain the information to associate with a token. As shown in flowchart in FIG. 2, after a token is received in the token receiving device 200, the token receiving device may offer the customer the opportunity to select various types of product-related information 205. In one embodiment, the customer can use the token-receiving device to choose which type of product-related information to retrieve. For example, the token-receiving device may include a user interface on which various types of product information are displayed for selection by the user. In some embodiments, the token-receiving device also may include an auxiliary input, such as a bar code scanner or RFID tag receiver, that allows the user to input information corresponding to the product for which information is desired. In anther embodiment, all possible types of product-related information may be retrieved with the token. In a different embodiment, only specifically requested product-related information may be retrieved.

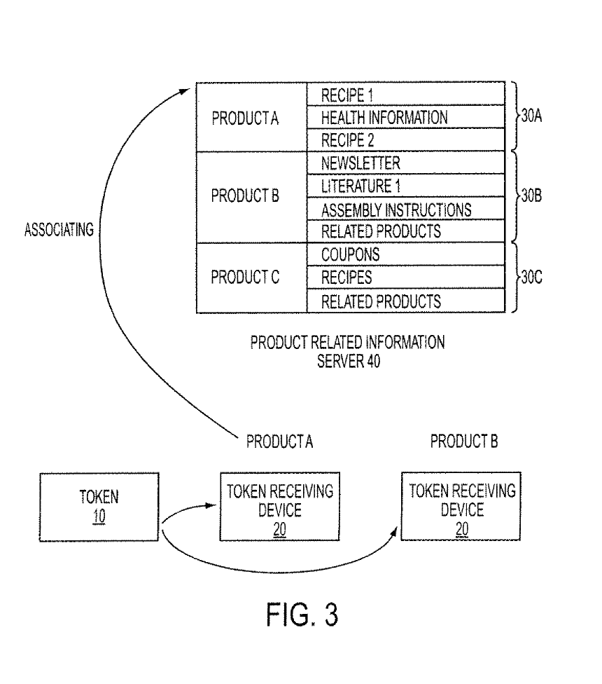

FIG. 3 shows a detailed embodiment of associating the product-related information 30 with the token. When the token 10 is received by the token-receiving device 20, the token 10 may be associated with a product of the token-receiving device. For example, the token-receiving device 20 may be associated with only a particular product, such as Product A. As a result, the token 10 may be associated with product-related information 30A about Product A. Alternatively, a token receiving device may be associated with multiple products, and the token may then be associated with particular product-related information 30B or 30C based on a customer selection. In one embodiment the customer may select the particular product-related information 30B or 30C by using an input interface which may include, but not limited to a touch screen, muse, keypad, scanner, or other optical or digital reader on the token-receiving device. In a further embodiment, the customer may select the particular product-related information 30B or 30C by using a scanning feature on the token-receiving device to scan the Universal Product Code (UPC) bar code or other code of the particular product, Product B or Product C.

The association between the token 10 and the product-related information 30 may related to a specific product or it may relate to a general category of products. For example, Product A can be tuna fish. The product-related information for Product A, as tuna fish, may include nutritional information for that particular brand of tuna, or it may include more general information such as tuna recipes.

In another example, there may be a token-receiving device 20 near a particular product, such as Product B. For example, Product B can be a bookshelf for sale in a store. If that token-receiving device 20 receives a different or the same token 10 from a customer, the token 10 can be associated with product-related information 30B for Product B. For example, the particular bookshelf can be associated with product-related information 30B such as newsletter, literature, assembly information and related products.

Once the token 10 is received by the token receiving device 20 at the point of display, the association of the token 10 data with the product-related information 30A, 30B and/or 30C can take place in any location. The association may be completed where the product-related information server 40 is located or it may be completed at another location. For example, the association can be completed in a location different from where the product is displayed or where the product-related information 30 is delivered. The information from the token 10 and the product-related information 30 may be associated in a remote location as the information can be received electronically or wirelessly from the point of display. In one embodiment, the customer request may be completed via a communications network such as the Internet.

As shown in FIG. 3, there may be more than one type of product-related information that is associated with a particular product. For example, Product A may be associated with a variety of recipes and health information 30A. The recipes are one type of product-related information, while the health-related information is another type of product-related information. Furthermore, in one embodiment, each recipe can be separately offered to the token holder, listed in the server (as shown with Product A) or multiple recipes can be offered to the token holder together as a signal unit (as shown with Product C).

Referring back to FIG. 2, the customer may chose to obtain all the information associated with the product or just a specific type of product-related information 210. If the customer makes no decision regarding the product-related information that the customer wants to receive, the system can default to associate all or a predetermined portion of the product-related information 215 with the token. Similarly, if the customer chooses to receive all the product-related information, then the system can associate all product-related information with the token 270. However, if the customer chooses to receive only selected information, the system may associate the chosen product-related information 225 and it optionally may also associate predetermined information with the token.

Next, the system will determine if the product was purchased 230. The product may be purchased by a customer at the point of sale. In one embodiment, the point of sale may include the location where a customer purchases the product and uses a second token receiving device to retrieve the product-related information. Alternatively, the point of sale may include the entire area where the product is purchased including, but not limited to, a conveyor belt, sales register and packing area. For example, the token may be a store rewards card that is received by a token receiving device at a checkout area of the store. In one embodiment, the system may identify a product for which the token holder requested product-related information, determine if the product was purchased 230, and if so request 240 the delivery 260 of the specific product-related information. This process is unlike using a credit card to receive a receipt at the point of sale because in this embodiment, the system must determine if the customer previously requested the product-related information. If the information was not previously requested at the point of display, or if the product was not purchased at the point of sale, then the system will not deliver the selected information 235. However, if the customer (i.e., the token user) did purchase the product associated with the request product-related information, then the system can retrieve the specifically chosen product-related information 240 and delivery it to the customer 260.

Similarly, after all the product-related information is associated 220 with the token, the system may determine if the associated product was purchased 245. If the product was not purchased, then nothing will be delivered and the system will finish 250. However, if the customer did buy the product, then the request product-related information for the purchased product may be retrieved 255, optionally along with predetermined product-related information, and the request and/or predetermined product-related information may be delivered to the customer 260.

For example, if inside a store a token receiving device is located near the display case for a food product, a customer can request product-related information, such as recipes, by using a token receiving device. The location of the product and the token receiving device are together to be considered the point of display. If the customer requests specific product-related information on how to cook that food on a grill, only that specific product-related information may be associated with that customer's token. Optionally, other predetermined product-related information, such as a coupon for future purchases of that product, also may be associated with the token. In one embodiment, when the customer goes to the point of sale to make a purchase, the customer may receive the requested and/or predetermined information only if the customer purchase the product. In this embodiment, the token may be used at a second token receiving device at the point of sale to determine if the product was purchased. If the customer purchased the product, the cooking instructions and optional other predetermine information may be retrieved for the customer.

Referring back to FIG. 1, after the product-related information 30 is retrieved, the information may be delivered to the information delivery device 50 at the point of delivery. The point of delivery is the location where the customer retrieves the product-related information 30. The point of delivery is not the point of display. Rather, the point of delivery is distant from the point of display in that the token holder must physically move to a second token receiving device in order to retrieve the information at a point of delivery. In one embodiment, the point of delivery may be located at the point of sale. In this embodiment, the customer may purchase the product and receive the product-related information 30 while the customer is physically present at a single same location. For example, the point of delivery may be a checkout counter, or a location within the reach of a typical customer while standing at the checkout counter. In another embodiment, the point of delivery may be located after the point of sale such as between a checkout counter and an exit of a store. For example, the customer may, at the point of sale, purchase the product and retrieve the product-related information 30 by applying the token to a kiosk located after checkout, near a store exit where a customer can retrieve the printed information. Alternatively, the product-related information may be electronically delivered to a central facility. In one embodiment, the central facility may print the product-related information 30. The point of delivery may be the central facility where a customer obtains the product-related information 30. Alternatively, the product-related information 30 may be mailed or e-mailed from the central facility to a customer. In one embodiment, the point of delivery may be the customer's home where a pamphlet of the product-related information 30 may be delivered via mail or e-mail where the e-mail address is obtained from the token.

In another embodiment, the product-related information 30 may be delivered via a website with a personalized uniform resource identifier (URI), such as a uniform resource locator (URL) which is printed at the point of sale. For example, the personalized URI could be printed on the cash register receipt or on a separate piece of paper at the point of sale terminal. Alteratively, the personalized URI may be e-mailed to the customer. The customer may then access the product-related information 30 via the URI. The customer may view the product-related information at the URI and download and print the product related information. The customer may download and/or print all of the product-related information 30 or the customer may selectively download and/or print specific product-related information 30.

The information delivery device 50 may have a variety of embodiments. In one embodiment, the information delivery device 50 may be a printer, copier or multifunction printing device. In another embodiment, the delivery may occur by printing the product-related request information at the checkout counter. In a different embodiment, the product-related information may be delivered to one of any number of printers available at a print station. In another embodiment, the information delivery device 50 may be a kiosk having print capabilities. Alternatively, the information delivery device 50 may be a device that delivers the product-related information 30 via the internet to a customer's home computer. In yet another embodiment, the document may be printed in a nearby location for the customer to retrieve, or it may be delivered to the customer by shipping the document to a home or office address.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
receiving a first token by a first token receiving device at a point of display of a product;
associating the token with product-related information;
determining whether the product was purchased;
retrieving the product-related information if the product was purchased; and
delivering the product-related information at a point of delivery, wherein the point of delivery is distant from the point of display.

2. The method of claim 1, wherein the determining whether the product was purchased includes receiving the token at a point of sale by a second token receiving device.

3. The method of claim 1, further comprising receiving, by the first token receiving device, a request for the product-related information.

4. The method of claim 3, wherein the associating includes associating the token with the requested product-related information.

5. The method of claim 4, wherein the associating includes associating the token with additional product-related information other than the requested information.

6. The method of claim 3, wherein the token-receiving device comprises an input interface to receive requests for the product related information.

7. The method of claim 6, wherein the input interface comprises a touch screen, mouse, keypad, optical receiver, or scanner.

8. The method of claim 1, wherein the point of delivery is the point of sale.

9. The method of claim 1, wherein the token comprises a storage device, card with a radio frequency identification tag, a card with a magnetic strip, or a card with an optical strip.

10. The method of claim 1, wherein the product-related information comprises a recipe, coupon, newsletter, health benefits description, list of complementary product, or instructions.

11. The method of claim 1, wherein the point of display is a product display location in a store, and the point of delivery is a checkout location in the store.

12. The method of claim 1, wherein the point of display is a product display location in a store, and the point of delivery is positioned after a checkout location and before an exit in the store.

13. The method of claim 1, wherein delivery the product-related information comprises e-mailing the product-related information.

14. The method of claim 1, wherein delivering the product-related information comprises printing the product-related information.

15. The method of claim 1, wherein the point of delivery comprises a print kiosk.

16. The method of claim 1 wherein delivering the product-related information comprises:
placing the product-related information on a website with a personalized uniform resource identifier; and
providing a holder of the token with the personalized uniform resource identifier.

17. The method of claim 16 wherein product-related information accessed via the personalized uniform resource identifier is downloaded and printed.

18. A system comprising:
a token;
a first token receiving device located at a point of display of a product in a store;
a product-related information server which receives a request for product-related information from the first token receiving device and retrieves the product-created information;
a second token receiving device located at a point of sale in the store; and
an information delivery device that delivers the product-related information at a point of delivery that is positioned at or after the point of sale.

19. The system of claim 18, wherein the first token reader also comprises a product information input mechanism.

20. The system of claim 19, wherein the product information input mechanism comprises a bar code scanner.

21. The system of claim 18, wherein the information delivery device comprises a printer.

22. The system of claim 18, wherein the token stores personal identification information corresponding to the user.

23. The system of claim 18, wherein the first token receiving device is associated with multiple products.
